(19) United States
(12) Patent Application Publication
(10) Pub. No.: US 2025/0299049 A1
(43) Pub. Date: Sep. 25, 2025

(54) BALANCED MULTIMODAL DATASET GENERATION FOR ANOMALY DETECTION

(71) Applicant: International Business Machines Corporation, Armonk, NY (US)

(72) Inventors: Aishwarya Melatur, Zurich (CH); Frederic Boesel, Freiburg (DE); Livio Schlaepfer, Zurich (CH); Mircea R. Gusat, Langnau am Albis (CH)

(21) Appl. No.: 18/615,121

(22) Filed: Mar. 25, 2024

(51) Int. Cl. G06N 3/09; G06N 3/04

(52) U.S. Cl. CPC G06N 3/09; G06N 3/04

(57) ABSTRACT

One or more computer processors labeling each timestep comprised in historical multivariate timeseries data logged from a plurality of systems. The one or more computer processors split each labeled timestep into a plurality of training sets, wherein each training set does not overlap with each remaining training set in the plurality of training sets. The one or more computer processors train a supervised model with the plurality of training sets, wherein the supervised model comprises a one dimensional convolutional layer, a one dimensional max pooling layer, and a dense layer. The one or more computer processors detect one or more anomalous timesteps within the new multivariate timeseries data utilizing the train supervised model. The one or more computer processors remediate one or more systems associated with the one or more anomalous timesteps.

### STATEMENT REGARDING PRIOR DISCLOSURES BY THE INVENTOR OR A JOINT INVENTOR

The following disclosure(s) are submitted under 35 U.S.C. 102(b)(1)(A):
(i) IBM Storage Insights Anomaly Detection; Aishwarya Melatur, Frederic Boesel, Livio Schlaepfer, Mircea R. Gusat; Sep. 28, 2023.

### BACKGROUND

The present invention relates generally to the field of machine learning, and more particularly anomaly detection.

Anomaly detection is an identification of rare items, events, or observations which deviate significantly from a majority of data and do not conform to a well-defined notion of normal behavior. Such examples may arouse suspicions of being generated by a different mechanism or appear inconsistent with the remainder of that set of data. Three broad categories of anomaly detection techniques exist. Supervised anomaly detection techniques that require a labeled data set and involves training a classifier, however, this approach is rarely used in anomaly detection due to the general unavailability of labelled data and the inherent unbalanced nature of the classes. Semi-supervised anomaly detection techniques that assume some portion of the data is labelled. Unsupervised anomaly detection techniques that assume data is unlabeled.

### SUMMARY

Embodiments of the present invention disclose a computer-implemented method, a computer program product, and a system. The computer-implemented method includes one or more computer processers labeling each timestep comprised in historical multivariate timeseries data logged from a plurality of systems. The one or more computer processors split each labeled timestep into a plurality of training sets, wherein each training set does not overlap with each remaining training set in the plurality of training sets. The one or more computer processors train a supervised model with the plurality of training sets, wherein the supervised model comprises a one dimensional convolutional layer, a one dimensional max pooling layer, and a dense layer. The one or more computer processors detect one or more anomalous timesteps within the new multivariate timeseries data utilizing the train supervised model. The one or more computer processors remediate one or more systems associated with the one or more anomalous timesteps.

### BRIEF DESCRIPTION OF THE DRAWINGS

FIG. (i.e., FIG.) 1 is a functional block diagram illustrating a computing environment, in accordance with an embodiment of the present invention;

FIG. 2 is a flowchart depicting operational steps of a program, on a computer within the computing environment of FIG. 1, for multimodal anomaly detection, in accordance with an embodiment of the present invention;

FIG. 3 is an illustration of an example of the operational steps of the program within the computing environment of FIG. 1, in accordance with an embodiment of the present invention;

FIG. 4 is an illustration of an example of the operational steps of the program within the computing environment of FIG. 1, in accordance with an embodiment of the present invention; and

FIG. 5 is an illustration of an example of the operational steps of the program within the computing environment of FIG. 1, in accordance with an embodiment of the present invention.

### DETAILED DESCRIPTION

Anticipating cloud infrastructure issues, through the use of data-center performance metric streams, is extremely important for any modern organization. Even minor cloud disruptions can propagate and reduce computational efficiency of associated systems; causing increased costs and wasted computational resources. For example, the traditional procedure of resolving cloud infrastructure errors with service ticket logging and support engineer intervention is a prohibitively time consuming undertaking, impacting business operations that rely on affected computational systems. Past approaches involve unsupervised learning models to detect anomalous patterns in streamed performance metrics that satisfy user verification through visual inspection, however, these detected anomalous patterns do not always correspond to actual service tickets raised by the user. Moreover, these detected false anomalous patterns increase a number of false positive detections which increases costs and computational wastage. Unsupervised anomaly detection models overwhelm users with unnecessary notification and alerts related to false positive detections, this issue is compounded as a consequence of traditional threshold detection methods.

Embodiments of the present invention propose a supervised learning pipeline consisting of a labeling scheme that generates a densely labeled frame from multimodal data (e.g., system tickets), a sample generation and balancing method that ensures each system within a training set is equally represented (e.g., sufficient anomalous samples with respect to normal samples), and a tailored evaluation metric. Embodiments of the present invention propose an automated timestep classification approach comprising a labeling procedure based on service tickets issued on a plurality of systems; a sample generation and balancing procedure that aggregates data and labels from the plurality of systems in order to provide a balanced large training dataset; and a task-specific evaluation metric that provides a rounded performance benchmark to further improve supervised models. Embodiments of the present invention propose an effective method to translate unsupervised anomaly detection on multivariate timeseries into a supervised learning equivalent.

Some embodiments of the present invention recognize that a challenge to effective and efficient anomaly detection model training is class imbalance as anomalies intrinsically rarely occur, which is exacerbated by a lack of proper metrics to evaluate model performance. Embodiments of the present invention utilize a plurality of tickets as a ground-truth to construct a dense set of labels, where each timestep in a timeseries is labeled, incorporating multi-system learning to counter class imbalance and subsequently evaluated using a task-specific metric. Embodiments of the present invention raise virtual tickets responsive to predicted anomalies; outputting a probability of anomaly at each timestep comprised in a multimodal data stream. Embodiments of the present invention train a model to predict a raising of a service ticket (i.e., virtual ticket) in advance of a user ticket (e.g., a ticket raised by the system user). Implementation of embodiments of the invention may take a variety of forms, and exemplary implementation details are discussed subsequently with reference to the Figures.

The present invention will now be described in detail with reference to the Figures.

FIG. 1 depicts computing environment 100 illustrating components of computer 101 in accordance with an illustrative embodiment of the present invention. It should be appreciated that FIG. 1 provides only an illustration of one implementation and does not imply any limitations with regard to the environments in which different embodiments may be implemented. Many modifications to the depicted environment may be made.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, defragmentation, or garbage collection, but this does not render the storage device as transitory because the data is not transitory while it is stored.

Computing environment 100 contains an example of an environment for the execution of at least some of the computer code involved in performing the inventive methods, such as multimodal anomaly detector 150, hereinafter referred to as program 150. In addition to program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip”. In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in program 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

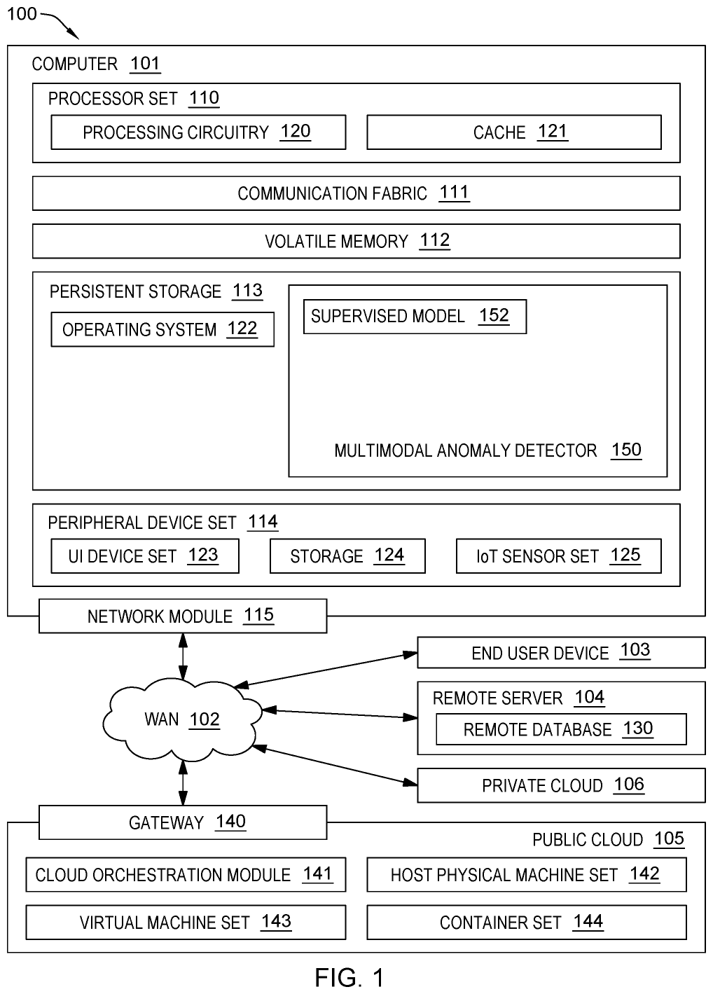

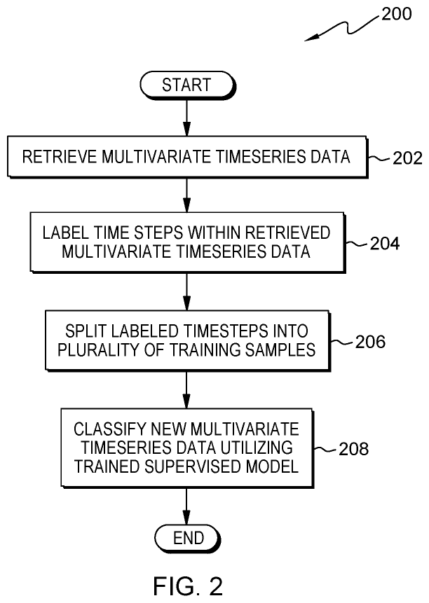

Multimodal anomaly detector 150 (i.e., program 150) is a program, a subprogram of a larger program, an application, a plurality of applications, or mobile application software, which functions to detect anomalies in multimodal data. In various embodiments, program 150 may implement the following steps: labeling each timestep comprised in historical multivariate timeseries data logged from a plurality of systems; splitting each labeled timestep into a plurality of training sets, wherein each training set does not overlap with each remaining training set in the plurality of training sets; training a supervised model with the plurality of training sets, wherein the supervised model comprises a one dimensional convolutional layer, a one dimensional max pooling layer, and a dense layer; detecting one or more anomalous timesteps within the new multivariate timeseries data utilizing the train supervised model; and remediating one or more systems associated with the one or more anomalous timesteps. In the depicted embodiment, program 150 is a standalone software program. In another embodiment, the functionality of program 150, or any combination programs thereof, may be integrated into a single software program. In some embodiments, program 150 may be located on separate computing devices (not depicted) but can still communicate over WAN 102. In various embodiments, client versions of program 150 resides on any other computing device (not depicted) within computing environment 100. In the depicted embodiment, program 150 includes supervised model 152. Program 150 is depicted and described in further detail with respect to FIG. 2.

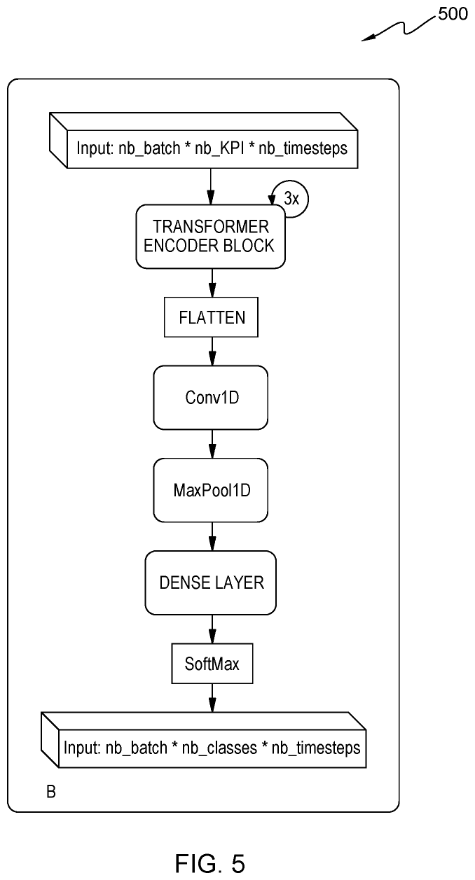

Supervised model 152 is representative of a model utilizing supervised learning techniques to train, calculate weights, ingest inputs, and output a plurality of solution vectors (e.g., anomaly probabilities or classifications (e.g., normal, anomalous)). In an embodiment, supervised model 152 is comprised of any combination of supervised learning model, technique, and algorithm (e.g., decision trees, Naive Bayes classification, support vector machines for classification problems, random forest for classification and regression, linear regression, least squares regression, logistic regression). In an embodiment, supervised model 152 utilizes transferrable neural networks algorithms and models (e.g., long short-term memory (LSTM), deep stacking network (DSN), deep belief network (DBN), convolutional neural networks (CNN), compound hierarchical deep models). The training and utilization of supervised model 152 is depicted and described in further detail with respect to FIGS. 2 and 5.

The present invention may contain various accessible data sources that may include personal storage devices, data, content, or information the user wishes not to be processed. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Program 150 may provide informed consent, with notice of the collection of personal data, allowing the user to opt in or opt out of processing personal data. Consent can take several forms: opt-in consent imposes on the user to take an affirmative action before the personal data is processed, alternatively, opt-out consent imposes on the user to take an affirmative action to prevent the processing of personal data before the data is processed. Program 150 enables the authorized and secure processing of user information, such as tracking information, as well as personal data, such as personally identifying information or sensitive personal information. Program 150 may provide information regarding the personal data and the nature (e.g., type, scope, purpose, duration.) of the processing. Program 150 may provide the user with copies of stored personal data. Program 150 may allow the correction or completion of incorrect or incomplete personal data. Program 150 may allow the immediate deletion of personal data.

References in the specification to “one embodiment”, “an embodiment”, “an example embodiment”, etc., indicate that the embodiment described may include a particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described.

FIG. 2 depicts flowchart 200 illustrating operational steps of program 150 for balanced multimodal anomaly detection, in accordance with an embodiment of the present invention.

Program 150 retrieves multivariate timeseries data (step 202). In an embodiment, program 150 initiates responsive to retrieving multivariate timeseries data (e.g., streaming multimodal data from one or more monitored systems (e.g., cloud infrastructure)). For example, a plurality of cloud systems records key performance indicators (KPIs) into a logging database and program 150 requests the KPIs (i.e., multivariate timeseries data) from the database. In an embodiment, KPIs are quantifiable measurements of improvement or deterioration in a performance of an activity which may include, but are not limited to, read/write speeds, network bandwidth, transfer size, response time, cache hits, cache misses, cache performance, open or closed network ports, errors, and processing unit indicators (e.g., GPU and CPU). In another embodiment, program 150 initiates responsive to an indication (e.g., user request) for a training or retraining of supervised model 152. In yet another embodiment, program 150 initiates responsive to a change (e.g., addition, modification, deletion) in a multivariate dataset. In an embodiment, the retrieved multivariate timeseries data comprises a sequence of timesteps or data points (e.g., KPIs) collected over a set of windows or time intervals (e.g., seconds, 5 minutes, a day). In another embodiment, the retrieved timeseries data comprises KPIs labeled with associated historical tickets. In various embodiments, program 150 utilizes one or more windows, containing one or more anomalies, obtained from an unsupervised learning pipeline as a multivariate, binary, timeseries input to supervised model 152. For example, program 150 directly feeds supervised model 152 with detected anomalies and associated KPIs.

In an embodiment, program 150 receives or retrieves all timeseries data (e.g., system and performance logs) generated by a plurality of systems. In another embodiment, program 150 receives or retrieves timeseries data (e.g., system and performance logs) for a plurality of systems for a selected period of time (e.g., a month). In an embodiment, program 150 sorts the retrieved timeseries data based on system criteria (e.g., system criticality, cost, historical tickets). For example, program 150 sorts the retrieved timeseries data based on respective system redundancy (e.g., more redundant systems are sorted (e.g., ranked) lower than less redundant systems). In an embodiment, program 150 selects a subset of systems utilizing a clustering technique. For example, program 150 selects a set of top 10 systems from a sorted list of systems utilizing density-based clustering, where the sorted list contains systems from a plurality of clusters. In another embodiment, program 150 selects a set of top systems from a sorted list of systems, where each system in the sorted list belongs to the same cluster. In various embodiments, program 150 utilizes KPIs only from selected systems.

Program 150 labels each timestep within retrieved multivariate timeseries data (step 204). In an embodiment, program 150 categorizes or sets a label for each timestep within the retrieved timeseries data associated with the set of selected systems. For example, program 150 labels each timestep as normal (i.e., non-anomalous), anomalous, or in maintenance, where in maintenance represents timesteps within a ticket (i.e., timesteps corresponding to anomaly detection and remediation). In another embodiment, program 150 labels timesteps as anomalous preceding timesteps associated with one or more historical tickets. For example, program 150 labels one or more timesteps corresponding to a 1 hour interval preceding a historical ticket, as anomalous. In another embodiment, program 150 maintains a dynamic interval (e.g., anomalous range) that determines a number of timesteps preceding a ticket that program 150 will subsequently label as anomalous. For example, program 150 adjusts an anomalous range to a first timestep of a ticket, but program 150 restricts the range to 3 hours from the first timestep, representing a natural time delay for traditional human intervention (i.e., remediation). In another embodiment, program 150 further defines a number of anomalous timesteps (i.e., anomalous range) to reduce dataset class imbalance. In yet another embodiment, all remaining timesteps are labeled as normal. In an embodiment, program 150 generates an array with a same length as the retrieved data, for example, program 150 creates an array that covers as much data as contained in a timestep. Responsively, program 150 fills the array with a one-hot encoded label set corresponding to a classification (i.e., label) at every timestep.

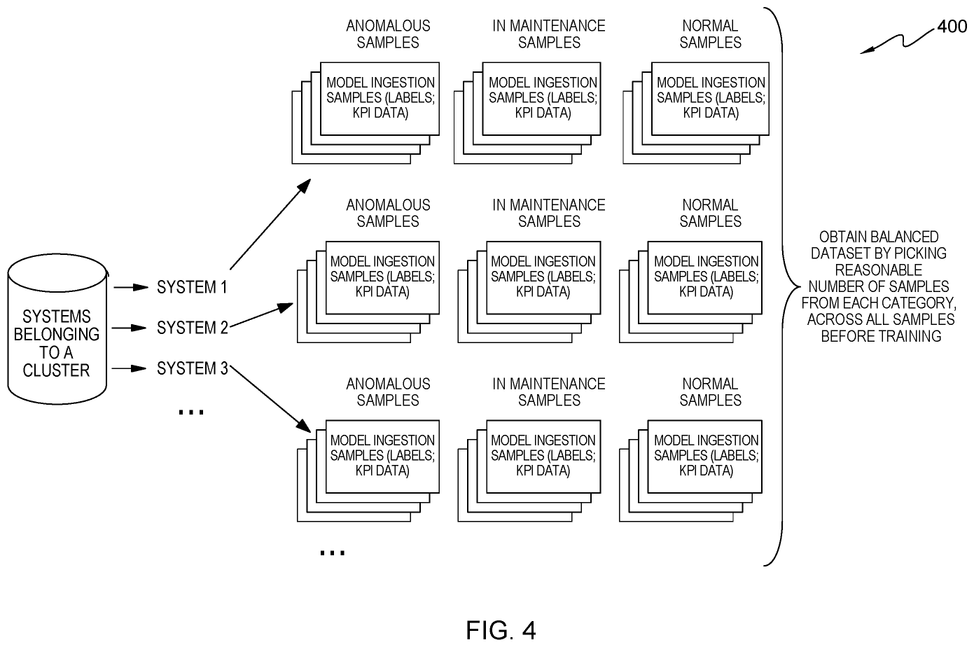

Program 150 splits the labeled timesteps into a plurality of training samples (step 206). Responsive to queried, preprocessed, and labeled multivariate data, program 150 splits the data into a plurality of training samples (e.g., splits, sets). In an embodiment, program 150 splits the data based on an ingestion length associated with supervised model 152 (e.g., number of timesteps defining a single training sample (e.g., 48 timesteps)). In another embodiment, program 150 categorizes (e.g., ‘normal’, ‘anomalous’, or ‘in maintenance’) each training sample based on a number of respective labels of comprised timesteps in each sample. For example, responsive to a training sample containing more than 12 timesteps with an associated ‘in maintenance’ label out of 28 total timesteps, program 150 labels the training sample as an ‘in maintenance’. In an embodiment, program 150 selects a plurality of balanced training samples, representative of all systems and labels, to train supervised model 152, where having too few systems (e.g., less than 10) represented in selected training samples undercuts model accuracy. In an embodiment, program 150 creates one or more training, validation, and testing samples. For example, program 150 creates the training, validation, and testing samples by splitting based on respective dates or date ranges. In this example, program 150 creates a training set spanning over an eight-month period of time, a validation set spanning a one-month period and a testing set spanning between three to four-months. In various embodiments, program 150 creates said splits, samples, or sets such that there is no data overlap between splits. In various embodiment, program 150 creates the splits across datasets representative of all systems within a selected set. FIG. 4 further illustrates dataset splitting as described above.

Responsive to a created sample, program 150 categorizes the created sample. In an example, program 150 categorizes each sample in the plurality of created samples into one of three categories in order to prevent or avoid training with ‘in maintenance’ samples. In this example, program 150 prevents a training of supervised model 152 with timesteps associated with ‘in maintenance’ labels, as further described in step 208. In another embodiment, program 150 prevents supervised model 152 from classifying subsequent timesteps responsive to a raised ticket, as further described in step 208.

Program 150 classifies new multivariate timeseries data utilizing a trained supervised model (step 208). In an embodiment, responsive to created samples, program 150 trains supervised model 152, further described in FIG. 5, utilizing the samples described in step 206. In an embodiment, program 150 utilizes a stride of a timepoint when defining training and validation samples, where this embodiment avoids look-ahead bias when training, as program 150 avoids feeding the model with data from the future when training. In another embodiment, program 150 implements a callback that computes an evaluation metric, as described below, for validation data at each training epoch, such that early stopping is effectively used.

In an embodiment, program 150 utilizes an objective loss function for training of supervised model 152, where the objective function is a categorical cross-entropy function:

$$- {Σ}_{c = 1}^{3} {y}_{c} log ( {p}_{c} ) , \qquad 1 )$$

with respect to equation (1), y_{c} is a binary indicator of a ground-truth class and p_{c} is a predicted output from supervised model 152 for a particular class, after a softmax activation has been applied. In an embodiment, program 150 does not consider every anomaly that leads to a ticket as a persistent, continuous set of KPIs, such that the anomaly does not need to continue uninterrupted in order for program 150 to categorize it as a true positive (TP). In another embodiment, program 150 ignores supervised model 152 outputs that occur during a ticket (e.g., within ground-truth in maintenance labels).

In an embodiment, program 150 utilizes event-wise recall (Recₑ) and point-wise precision (Prₜ) to create a composite F1 score (F_{c1}) to evaluate supervised model 152 on a per timestep basis as follows:

$$P {r}_{t} = \frac{T {P}_{t}}{T {P}_{t} + F {P}_{t}} \qquad 2 )$$

$${Rec}_{e} = \frac{T {P}_{e}}{T {P}_{e} + F {N}_{e}} \qquad 3 )$$

$${F}_{c 1} = \frac{2 * P {r}_{t} * R e {c}_{e}}{P {r}_{t} + R e {c}_{e}} \qquad 4 )$$

with respect to equations (2), (3), and (4), where TPₜ is a true positive, FPₜ is a false positive, and FNₑ is a false negative. Equation (4) is a modified composite F1 score such that program 150 utilizes F_{c1} to reward an anomalous prediction within a timeframe, t_{pred}, before a ticket, while punishing excessive anomalous predictions not within t_{pred} before a ticket (e.g., program 150 ignores outputs during an in maintenance phase for each ticket and for data gaps (i.e., state of the KPIs are unknown)). In an embodiment, program 150 computes t_{pred} for a range of timeframes (e.g., from a few hours to a few days) due to the fact that t_{pred} is unknown until a ticket is raised. In an embodiment, program 150 calculates true positives in two manners: TPₜ (i.e., number of anomalous timesteps within a t_{pred} window) or TPₑ, wherein program 150 sets TPₑ=1 for every ticket if there is at least one anomalous timestep in a corresponding window, otherwise program 150 sets FNₑ=1. In another embodiment, program 150 sets FPₜ to a number of anomalous timesteps outside maintenance phases, data gaps, and t_{pred} windows. In yet another embodiment, program 150 sums the obtained values of TPₜ, TPₑ, FNₑ, and FPₜ for each t_{pred}, over each system, and, responsively computes a global (e.g., across all systems) Recₑ, Prₜ, and F_{c1} scores.

In an embodiment, F_{c1} is a monotonically increasing function with respect to t_{pred}, for a given set of TPₜ, FNₑ and TPₑ values, as it gets increasingly likely that an anomalous prediction occurs within a window as the window also increases (e.g., for a given ticket: TPₑ=1 and FNₑ=0, thus increasing Recₑ), and more anomalous predictions are rewarded as TPₜ instead of being penalised as FPₜ, thus increasing Prₜ. In another embodiment, program 150 adds a penalizing term to F_{c1}, such as −kt_{pred}, to make F_{c1} concave with respect to t_{pred}. In an embodiment, program 150 compares respective metrics for each t_{pred}, as F_{c1} monotonically increases, to compare model (e.g., supervised model 152) performance (e.g., accuracy, precision, recall). In an embodiment, program 150 calculates a model certainty score by calculating and responsively, plotting, max(σ(z))−min(σ(z)), where z is raw output at each timestep and σ is a softmax operator. In another embodiment, program 150 encodes a calculated certainty score or probability of an anomaly or a ticket causing the anomaly within labels. In a further embodiment, program 150 encodes the calculations or probabilities utilizing one or more ground-truths. For example, program 150 sets one or more sample weights such that supervised model 152 weighs a respective sample inside of a loss function responsive to encountering the respective sample during training. In an embodiment, program 150 continues to train or retrain supervised model 152 until supervised model 152 meets or exceeds a performance threshold.

Responsive to trained supervised model 152 and new multivariate timeseries data, program 150 predicts and raises one or more virtual tickets by inputting the new multivariate timeseries data into trained supervised model 152. In another embodiment, program 150 raises a virtual ticket by classifying each timestep (e.g., dense predictions) according to the labeling procedure described in step 204 and 206. In a further embodiment, program 150 utilizes supervised model 152 to output a one or more dense predictions, wherein an input length (e.g., ingestion window length, a number of processed timesteps at a given time) is equal to an output window length. In another embodiment, program 150 utilizes said dense predictions in an evaluation metric, as described above, instead of utilizing segment predictions, in order to precisely evaluate a usefulness of supervised model 152 by numerating and evaluating individual timestep predictions.

In an embodiment, program 150 inputs the new multivariate timeseries data into supervised model 152, where supervised model 152 comprises a plurality of transformer encoders that create a respective contextualized embedding (i.e., a context of each timestep in a sample, across all KPIs) for one or more timesteps contained in the new multivariate timeseries data, resulting in one or more tensors. Responsively, program 150 flattens the one or more tensors and compresses the flatten tensors through Conv1D (i.e., a one dimensional convolution layer) and MaxPool1D (i.e., one dimensional max pooling layer) operations, in order to obtain a same-size vector as the input (e.g., in time). In an example, program 150 utilizes a number of units per timestep to serve as a one-hot encoded output representing each class (e.g., anomalous, normal, in maintenance), wherein program 150 sets the number of units per timestep to the number of classes or categories. Responsively, program 150 applies softmax (i.e., normalizes the output to a probability distribution over a set of predicted output classes) to the one-hot encoded output). In various embodiments, program 150 utilizes an entire sample window to categorize (i.e., predict) a timestep, such that there is no loss of information when utilizing dense predictions instead of segment predictions. In an embodiment, program 150 outputs a probability of anomaly at each timestep comprised in multimodal data. In another embodiment, program 150 trains supervised model 152 to predict a raising of a service ticket (i.e., virtual ticket) in advance of a user ticket (e.g., a ticket raised by a user).

Responsive to a detected anomaly or a raised virtual ticket, program 150 remediates one or more systems associated with the detected anomaly or ticket. In an embodiment, program 150 transmits a generated notification to one or more users, where program 150 generates the notification with details required for the remediation of the anomaly (e.g., required remediation components, required remediation permissions, safety considerations, estimated remediation duration (e.g., in maintenance)). In such an embodiment, program 150 suspends classifying subsequent timesteps until the anomaly is remediated. In another embodiment, program 150 applies a remediation procedure associated with the remediation of one or more historical tickets that are similar to the raised ticket. For example, program 150 applies a historical remediation for an anomaly, associated with increased database latency, to a raised ticket with a similar KPIs.

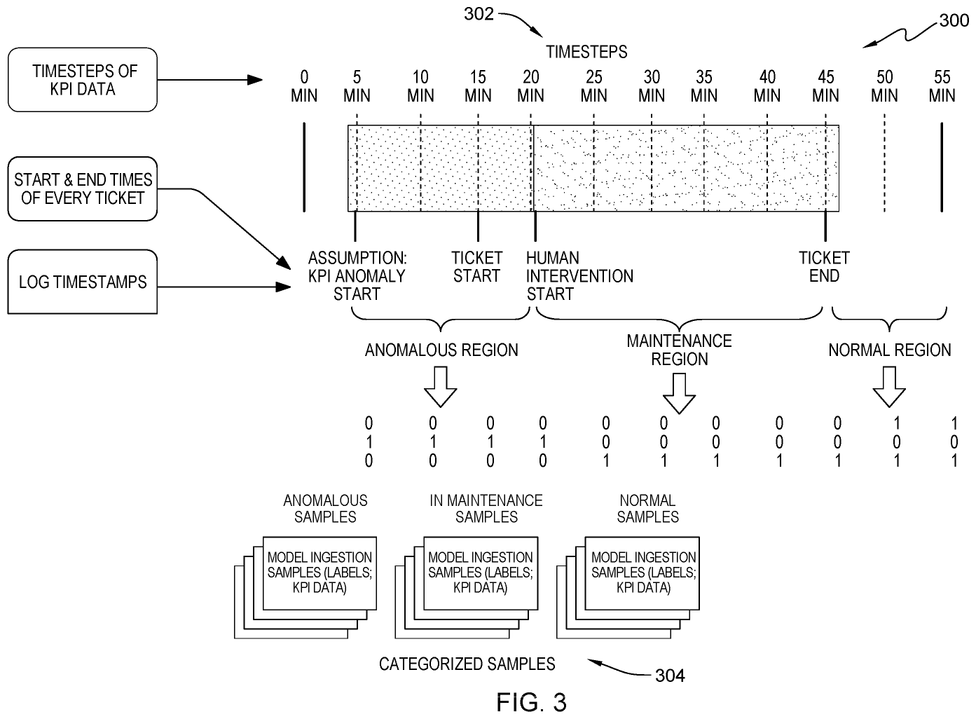

FIG. 3 depicts example 300, in accordance with an illustrative embodiment of the present invention. Example 300 includes timesteps 302 and categorized samples 304 that illustrate program 150 automatically labeling one or more samples, as described in step 204. Timesteps 302 depict a set of KPIs associated with a historical ticket with an identified anomaly, ticket starts, and when remediation occurred. Categorized samples 304 depict a plurality of timesteps 302, in which each timeseries is aggregated into a larger sample set. Responsively, program 150 categorizes each sample as ‘anomalous’, ‘normal’, or ‘in maintenance’. Example 300 further illustrates program 150 generating one or more sample windows and categorizing said windows.

FIG. 4 depicts example 400, in accordance with an illustrative embodiment of the present invention. Example 400 illustrates program 150 balancing a training dataset, as described in step 206. Example 400 illustrates program 150 querying from multiple systems and categorizing one or more timeseries' obtained from the systems. In an embodiment, program 150 obtains a balanced training dataset by randomly selecting a number of samples from each class (e.g., anomalous, non-anomalous, in maintenance), across each system, prior to training supervised model 152.

FIG. 5 depicts example model 500, in accordance with an illustrative embodiment of the present invention. Example model 500 is representative of an embodiment of supervised model 152. Example model 500 demonstrates program 150 feeding an input into supervised model 152 which in turn utilizes three transformer encoder blocks create a contextualized embedding of each timestep within the input. The result is flattened and compressed through Conv1D and MaxPool1D operations to obtain a vector that has equal size to the input, for example, three units per timestep that serve as a one-hot encoded output. Responsively, program 150 applies softmax to the one-hot encoded output, which is utilized as a respective prediction for each timestep.

What is claimed is:

1. A computer-implemented method comprising:
labeling each timestep comprised in historical multivariate timeseries data logged from a plurality of systems;
splitting each labeled timestep into a plurality of training sets, wherein each training set does not overlap with each remaining training set in the plurality of training sets;
training a supervised model with the plurality of training sets, wherein the supervised model comprises a one dimensional convolutional layer, a one dimensional max pooling layer, and a dense layer;
detecting one or more anomalous timesteps within the new multivariate timeseries data utilizing the train supervised model; and
remediating one or more systems associated with the one or more anomalous timesteps.

2. The computer-implemented method of claim 1, wherein labeling each timestep, comprises:
labeling each timestep as a selection from the group consisting of anomalous, non-anomalous, or in maintenance.

3. The computer-implemented method of claim 1, wherein splitting each labeled timestep into the plurality of training sets, comprises:
splitting each labeled timestep based on an ingestion length associated with the supervised model; and
categorizing each training set in the plurality of training sets.

4. The computer-implemented method of claim 2, wherein training the supervised model with the plurality of training sets, comprises:
training the supervised model with timesteps labeled as a selection from the group consisting of anomalous or non-anomalous; and
preventing training the supervised model with timesteps labeled as in maintenance.

5. The computer-implemented method of claim 1, further comprising:
creating a composite score to evaluate the trained supervised model.

6. The computer-implemented method of claim 5, wherein the composite score is a monotonically increasing function with respect to a timeframe preceding a raised ticket.

7. The computer-implemented method of claim 2, further comprising:
encoding a calculated probability of an anomaly within one or more labeled timesteps.

8. A computer program product comprising:
one or more computer readable storage media having computer-readable program instructions stored on the one or more computer readable storage media, said program instructions executes a computer-implemented method comprising steps of:
labeling each timestep comprised in historical multivariate timeseries data logged from a plurality of systems;
splitting each labeled timestep into a plurality of training sets, wherein each training set does not overlap with each remaining training set in the plurality of training sets;
training a supervised model with the plurality of training sets, wherein the supervised model comprises a one dimensional convolutional layer, a one dimensional max pooling layer, and a dense layer;
detecting one or more anomalous timesteps within the new multivariate timeseries data utilizing the train supervised model; and
remediating one or more systems associated with the one or more anomalous timesteps.

9. The computer program product of claim 8, wherein the program instructions to label each timestep, stored on the one or more computer readable storage media, comprise the steps of:
labeling each timestep as a selection from the group consisting of anomalous, non-anomalous, or in maintenance.

10. The computer program product of claim 8, wherein the program instructions to split each labeled timestep into the plurality of training sets, stored on the one or more computer readable storage media, comprise the steps of:
splitting each labeled timestep based on an ingestion length associated with the supervised model; and
categorizing each training set in the plurality of training sets.

11. The computer program product of claim 9, wherein the program instructions to train the supervised model with the plurality of training sets, stored on the one or more computer readable storage media, comprise the steps of:
training the supervised model with timesteps labeled as a selection from the group consisting of anomalous or non-anomalous; and
preventing training the supervised model with timesteps labeled as in maintenance.

12. The computer program product of claim 8, wherein the program instructions, stored on the one or more computer readable storage media, further comprise the steps of:
creating a composite score to evaluate the trained supervised model.

13. The computer program product of claim 12, wherein the composite score is a monotonically increasing function with respect to a timeframe preceding a raised ticket.

14. The computer program product of claim 9, wherein the program instructions, stored on the one or more computer readable storage media, further comprise the steps of:
encoding a calculated probability of an anomaly within one or more labeled timesteps.

15. A computer system comprising:
one or more computer processors;
one or more computer readable storage media having computer readable program instructions stored on the one or more computer readable storage media for execution by at least one of the one or more processors, the stored program instructions execute a computer-implemented method comprising steps of:
labeling each timestep comprised in historical multivariate timeseries data logged from a plurality of systems;
splitting each labeled timestep into a plurality of training sets, wherein each training set does not overlap with each remaining training set in the plurality of training sets;
training a supervised model with the plurality of training sets, wherein the supervised model comprises a one dimensional convolutional layer, a one dimensional max pooling layer, and a dense layer;
detecting one or more anomalous timesteps within the new multivariate timeseries data utilizing the train supervised model; and
remediating one or more systems associated with the one or more anomalous timesteps.

16. The computer system of claim 15, wherein the program instructions to label each timestep, stored on the one or more computer readable storage media, comprise the steps of:
labeling each timestep as a selection from the group consisting of anomalous, non-anomalous, or in maintenance.

17. The computer system of claim 15, wherein the program instructions to split each labeled timestep into the plurality of training sets, stored on the one or more computer readable storage media, comprise the steps of:
splitting each labeled timestep based on an ingestion length associated with the supervised model; and
categorizing each training set in the plurality of training sets.

18. The computer system of claim 16, wherein the program instructions to train the supervised model with the plurality of training sets, stored on the one or more computer readable storage media, comprise the steps of:
training the supervised model with timesteps labeled as a selection from the group consisting of anomalous or non-anomalous; and
preventing training the supervised model with timesteps labeled as in maintenance.

19. The computer system of claim 15, wherein the program instructions, stored on the one or more computer readable storage media, further comprise the steps of:
creating a composite score to evaluate the trained supervised model.

20. The computer system of claim 19, wherein the composite score is a monotonically increasing function with respect to a timeframe preceding a raised ticket.
